(19) United States
(12) Patent Application Publication
(10) Pub. No.: US 2026/0027775 A1
(43) Pub. Date: Jan. 29, 2026

(54) MOUNTING RACK AND TOOL FOR THREE-DIMENSIONAL PRINTING SYSTEM

(71) Applicants: NISSAN NORTH AMERICA, INC., Franklin, TN (US); NORTHWESTERN UNIVERSITY, Evanston, IL (US); ÉCOLE DE TECHNOLOGIE SUPÉRIEURE, UNIVERSITÉ DU QUÉBEC, Montreal (CA)

(72) Inventors: Pengpeng ZHANG, Evanston, IL (US); Cheng SUN, Evanston, IL (US); Ilian BONEV, Montreal (CA); Yasser KRIM, Montreal (CA); Evan JONES, Evanston, IL (US); Nanzhu ZHAO, Novi, MI (US); Evan ROLLAND, Montreal (CA)

(21) Appl. No.: 18/783,401

(22) Filed: Jul. 24, 2024

(51) Int. Cl. B29C 64/25; B29C 64/227; B29C 64/245; B29C 64/255; B29C 64/264; B33Y 30/00

(52) U.S. Cl. CPC B29C 64/25; B29C 64/227; B29C 64/245; B33Y 30/00; B29C 64/255; B29C 64/264

(57) ABSTRACT

A three-dimensional printing system includes a printing tool, a control arm, and a mounting rack. The printing tool includes a rigid base on which an object is configured to be printed. The control arm is removably connected to the rigid base and is configured to move the rigid base. The mounting rack is configured to store a plurality of printing tools. The mounting rack includes a support member and a plurality of recesses disposed in the support member. Each of the plurality of recesses is configured to receive one of the plurality of printing tools. A plurality of first openings is disposed in the support member and surrounds each of the plurality of recesses. A magnet is disposed in one of the plurality of first openings. A spring ball plunger is disposed in another one of the plurality of first openings.

### BACKGROUND

### Technical Field

The present disclosure generally relates to a mounting rack and a tool for a robot-assisted system. More specifically, the present disclosure relates to a mounting rack and a tool for a three-dimensional printing system.

### Background Information

Three-dimensional (3D) printing is the construction of a three-dimensional object from a digital file, such as a CAD model or a digital 3D model. In one method of 3D printing, the objects are printed layer by layer by the 3D printing system by curing portions of a light curable photopolymer resin layer by layer, one layer at a time, within a printing area of a tank filled with the photopolymer resin. A curing device, such as an ultraviolet light source, is projected through a transparent substrate or bottom wall of the tank curing each layer of the object on a build plate, or rigid base, that is initially at least partially submerged within the photopolymer resin. The build plate is incrementally translated and rotated as each new layer is cured beneath the previous layer.

The build plate is connected to a robotic arm. When an object has been printed, the build plate is removed from the robotic arm. The build plate can be removed from one robotic arm to be picked up by another robotic arm for post-printing processing, such as rinsing or curing, thereby allowing the one robotic arm to print another object. Removing and attaching build plates from and to the robotic arm slows down a printing speed of the system. Additionally, improperly positioning the removed build plate at a mounting rack of a tool station can make subsequent picking up of the build plate by a robotic arm difficult or even impossible.

### SUMMARY

A need exists for an improved mounting rack and tool of a three-dimensional printing system.

In view of the state of the known technology, one aspect of the present disclosure is to provide a three-dimensional printing system including a printing tool, a control arm, and a mounting rack. The printing tool includes a rigid base, or build plate, on which an object is configured to be printed. The control arm is removably connected to the rigid base and is configured to move the rigid base. The mounting rack is configured to store a plurality of printing tools. The mounting rack includes a support member and a plurality of recesses disposed in the support member. Each of the plurality of recesses is configured to receive one of the plurality of printing tools. A plurality of first openings is disposed in the support member and surrounds each of the plurality of recesses. A magnet is disposed in one of the plurality of first openings. A spring ball plunger is disposed in another one of the plurality of first openings.

Another aspect of the present disclosure is to provide a robot-assisted system including a tool, a control arm, and a mounting rack. The control arm is removably connected to the tool and is configured to move the tool. The mounting rack is configured to store a plurality of tools. The mounting rack includes a support member and a plurality of recesses disposed in the support member. Each of the plurality of recesses is configured to receive one of the plurality of tools. A plurality of first openings is disposed in the support member and surrounds each of the plurality of recesses. A magnet is disposed in one of the plurality of first openings. A spring ball plunger is disposed in another one of the plurality of first openings.

Also other objects, features, aspects and advantages of the disclosed mounting rack and tool for a three-dimensional printing system will become apparent to those skilled in the art from the following detailed description, which, taken in conjunction with the annexed drawings, discloses exemplary embodiments of a mounting rack and tool for a three-dimensional printing system.

### BRIEF DESCRIPTION OF THE DRAWINGS

Referring now to the attached drawings which form a part of this original disclosure:

FIG. 1 is a perspective view of a three-dimensional printing system in accordance with an exemplary embodiment;

FIG. 2 is a perspective view in which a tool is connected to a control arm of the three-dimensional printing system of FIG. 1;

FIG. 3 is a perspective view of a mounting rack and a printing tool of the three-dimensional printing system of FIG. 1;

FIG. 4 is a perspective view of the mounting rack and the printing tool of FIG. 3 prior to the mounting rack receiving the printing tool;

FIG. 5 is a perspective view of the mounting rack receiving the printing tool of FIG. 4;

FIG. 6 is a perspective view of the mounting rack of FIG. 3;

FIG. 7 is a bottom plan view of the printing tool of FIG. 3;

FIG. 8 is a side perspective view of the mounting rack receiving the printing tool of FIG. 5;

FIG. 9 is an elevational view of a receiving member of the printing tool engaging a spring ball plunger of the mounting rack; and

FIG. 10 is an elevational view of the receiving member of the printing tool further engaging the spring ball plunger of the mounting rack of FIG. 9.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

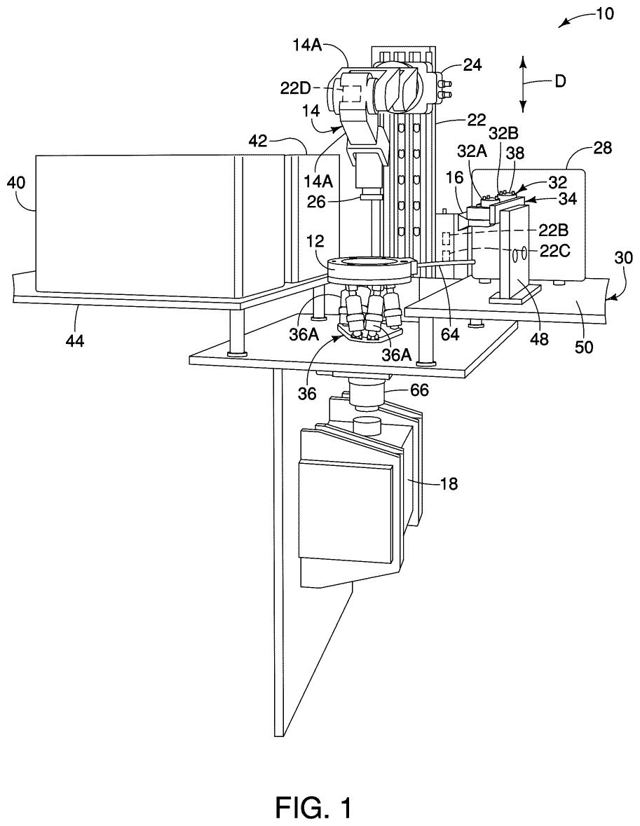

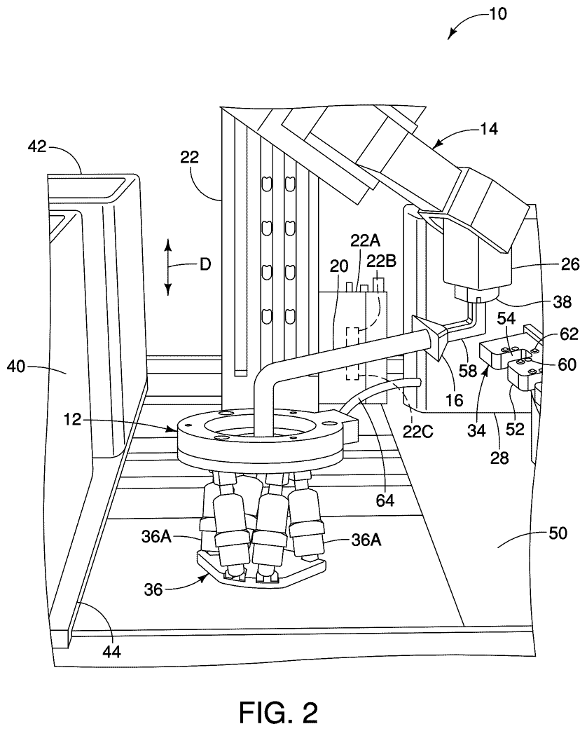

Referring initially to FIGS. 1 and 2, a robot-assisted system, such as a three-dimensional printing system 10, in accordance with an exemplary embodiment includes a tank 12 configured to contain a liquid photopolymer resin. A control arm 14 is configured to be movable relative to the tank 12. A tool, such as a printing tool 32, is connectable to and removable from the control arm 14. The printing tool 32 includes a rigid base 16 on which an object is configured to be printed. The control arm 14 is removably connected to the rigid base 16 and is configured to move the rigid base 16 of the printing tool 32 relative to the tank 12. A light source 18 is configured to emit light to the tank 12 to form a printed object 20 on the rigid base 16 of the printing tool 32.

Although the description is directed to a printing tool 32, as shown in FIGS. 1-4, 7 and 8, the robot-assisted system is equally applicable to any suitable tool in which the control arm 14 is removably connected to the tool and configured to move the tool, such as a 3D printing system in which a part is built on an end-effector of a control arm.

A guide rail 22 is mounted externally of the tank 12, as shown in FIGS. 1 and 2. The arm 14 is configured to move linearly in a direction D along the guide rail 22. The guide rail 22 can include an integrated linear motor, or any other suitable means of moving the arm 14 along the guide rail 22, and a controller 22B configured to control linear movement of the arm 14 along the guide rail 22. The controller 22B can be disposed in a housing 22A disposed adjacent to the guide rail 22. The controller 22B can control movement of the arm 14 along the guide rail 22. The arm 14 includes a slide 24 movably connected to the guide rail 22. The slide 24 is configured to move in the direction D along the guide rail 22. In other words, the slide 24 moves linearly along the guide rail 22 to position the arm 14 relative to the tank 12. The slide 24 is configured for precise linear movement along the guide rail 22 with high accuracy. The arm 14 is configured to be movable relative to the tank 12 along the guide rail 22 to control movement of the rigid base 16 of the printing tool 32. The guide rail 22 increases a work region of the arm 14 to facilitate printing elongated and complex objects. The linear movement of the base 24 and the arm 14 are controlled during the printing process in accordance with the digital file for the object to be printed. A controller 22D controls movement of the arm 14. The controller 22D can be disposed in the arm 14, as shown in FIG. 1, or located externally, such as in the housing 22A.

As shown in FIGS. 1 and 2, the tank 12 contains a liquid photopolymer resin. The tank 12 can be any suitable shape to hold the liquid polymer resin therein, such as rectangular or circular. The tank 12 has a base and a side wall extending upwardly from the base. The base is preferably transparent such that the light emitted from the light source 18 can pass through the base. The entirety of the base can be transparent, or a portion of the base can be transparent. The transparent portion of the base constitutes an optically transparent window through which the emitted light from the light source 18 can pass. A supply pipe 64 can be connected to the tank 12 to supply additional liquid photopolymer resin to the tank 12 to allow for continuous printing of a plurality of objects.

The rigid base 16 of the printing tool 32 provides a print surface 16A on which the object 20 is printed, as shown in FIGS. 2-4. The print surface 16A is preferably a planar surface. The rigid base 16 of the printing tool 32 can be made of any suitable material, such as plastic, such as polyactic acid (PLA), or glass. The printing tool 32 includes a connecting member 38 configured to be removably connected to a tool adapter 26 in any suitable manner. A connecting arm 58 connects the rigid base 16 and the connecting member 38. The connecting arm 58 can have any suitable shape, such as being substantially L-shaped, as shown in FIGS. 2-4. In other words, the connecting arm 58 has a ninety degree bend to facilitate printing an object on the print surface 16A of the rigid base 16. The ninety degree bend in the connecting arm 58 facilitates printing of a larger object. The print surface 16A is disposed substantially perpendicularly to the connecting surface 38B of connecting member 38. The print surface 16A is offset from the connecting surface when viewed from above. In other words, a center, longitudinal axis through the connecting member 38 does not pass through the print surface 16A, as shown in FIG. 4.

The liquid polymer resin is selectively cured by light-activated polymerization, such as by photopolymerization, which preferably uses visible or UV light, although light having any suitable wavelength can be used, to form in situ cross-linked polymer structures. The liquid photopolymer resin preferably includes monomer and oligomer molecules that are converted to solid polymers during photopolymerization when the light emitted by the light source 18 is guided through the transparent portion, or the optically transparent window, of the base of the tank 12. The supply pipe 64 connected to the tank 12, as shown in FIGS. 1 and 2, supplies additional liquid photopolymer resin to the tank 12 to allow for continuous printing of a plurality of objects. The supply pipe 64 is fluidly connected between the tank 12 and a refuel tank 28, as shown in FIGS. 1 and 2. The refuel tank 28 stores liquid photopolymer resin to be supplied to the tank 12. In other words, the refuel tank 28 is fluidly connected to the tank 12 to supply liquid photopolymer resin to the tank 12.

The light source 18 emits light to cure the liquid polymer resin in the tank 12, as shown in FIG. 1. The light source 18 preferably emits UV light having a wavelength between approximately 10 and 400 nanometers, inclusive. Preferably, the emitted UV light has a wavelength between approximately 380 and 400 nanometers, inclusive. Light having any suitable wavelength can be used, such as, but not limited to, UV, visible and infrared light. The light emitted by the light source 18 is configured to pass through openings in an actuator 36, and through the transparent window of the tank 12 to solidify the liquid photopolymer resin layer by layer on the rigid base 16 of the printing tool 32.

As shown in FIG. 1, a lens 66 can be disposed between the light source 18 and the tank 12. The lens 66 is configured to adjust a resolution of the emitted light. The lens 66 is selected based on a desired focal depth.

The control arm 14 is connected to the rigid base 16 to control movement and positioning of the rigid base 16 during the printing process. The control arm 14 is connected to the rigid base 16 to move the rigid base 16 relative to the tank 12 during the printing process. The control arm 14 includes a plurality of links 14A independently movable relative to each other to provide highly accurate positioning of the rigid base 16. The control arm 14 preferably has six degrees of freedom, such that the rigid base 14 can move through a curvilinear path to more accurately print the object 20. The control arm 14 is preferably a robotic arm having six degrees of freedom. The six degrees of freedom are movements along the three axes (i.e., the X, Y and Z axes), and rotation about each of the three axes (i.e., pitch, roll and yaw). Providing the control arm 14 with multiple degrees of freedom, such as six degrees of freedom, allows the control arm 14 to move the rigid base 16 through a curvilinear path, including moving the rigid base 16 to a plurality of positions, thereby allowing a more accurate and intricate object 20 to be printed.

The tool adapter 26 is configured to be connected to the control arm 14, as shown in FIGS. 1 and 2. The tool adapter 26 is removably connected to one of the links 14A of the arm 14 in any suitable manner. Preferably, the tool adapter 26 is connected to the link 14A farthest from the slide 24. The tool adapter 26 facilitates removably connecting a plurality of components, or tools, to the arm 14. The components are removably connected to the tool adapter 26 in any suitable manner.

A tool station 30 is disposed proximate to the tank 12, as shown in FIG. 1. The tool station 30 is configured to store a plurality of printing tools 32. Each of the printing tools 32 is configured to be removably received by a mounting rack 34 of the tool station 30 and to be removably connected to the tool adapter 26. Each of the printing tools 32 is configured to be automatically connected to and removed from the tool adapter 26 in a conventional manner. The tool station 30 includes a platform 50 on which the mounting rack 34 is disposed. The mounting rack 34 is configured to removably receive the plurality of printing tools 32.

The print control program controls operation of the arm 14 to move the arm 14 to the tool station 30 to connect and remove one of the printing tools 32 from the mounting rack 34, as shown in FIGS. 1 and 2. A first printing tool 32A is connected to the tool adapter 26 to print a first object, as shown in FIG. 2. When the first object 20 is printed, the first printing tool 32A is removed from the tool adapter 26 and a second printing tool 32B is connected to the tool adapter 26 to print a second object. The removal of the first printing tool 32A and the connection of the second printing tool 32B occurs automatically without human intervention, thereby requiring precise positioning of the printing tool 32 on the mounting rack 34. The first printing tool 32A is returned to the mounting rack 34, as shown in FIG. 4, and the second printing tool 32B is attached to the tool adapter 26 of the arm 14. A printed object can be repeatedly printed by storing a plurality of printing tools 32 at the mounting rack 34 of the tool station 30. Each of the printing tools 32 is configured to be removed from the tool adapter 26 with the printed object attached to the rigid base 16, as shown in FIG. 4.

Referring to FIGS. 1 and 2, the alignment actuator 36 is configured to adjust a position of the tank 12 to align a bottom surface of the tank 12 with the light source 18. Additionally, the alignment actuator 36 can be used to facilitate flow of the liquid polymer resin in the tank 12 during the printing process. Movement of the liquid polymer resin in the tank 12 during the printing process facilitates flow of the resin to substantially prevent the printed object from adhering to the transparent window of the tank 12. The actuator 36 is connected to an electronic controller 22C, as shown in FIG. 1, to control movement of each of a plurality of legs 36A, thereby providing precise positioning of the tank 12. The actuator 36 allows positioning of the tank 12 about six axes (the X, Y and Z axes, and pitch, roll and yaw).

As shown in FIG. 1, the 3D printing system 10 can include any suitable number of post-processing stations. The 3D printing system 10 preferably includes a first post-processing station 40 and a second post-processing station 42. The post-processing stations further process the printed object 20 after the printed object 20 is removed from the tank 12, such as washing and curing the printed object. The printed object 20 passes through the first post-processing station 40 and the second post-processing station 42 while the printed object 20 is still connected to the rigid base 16. The printing tool 32 can be returned to the mounting rack 34 of the tool station 30 such that another control arm can pick up the printed object for post-processing of the printed object 20. Alternatively, the control arm 14 can move the printed object 20 through the post-processing stations.

The first post-processing station 40 is preferably a curing station, and the second post-processing station 42 is preferably a washing station. The first and second post-processing stations 40 and 42 are preferably disposed on the same platform 44, as shown in FIG. 1.

The first post-processing station 40, as shown in FIGS. 1 and 2, is a post-washing station configured to wash the printed object 20 externally of the tank 12. Post-washing removes any residual, uncured resin from the printed object 20. The first post-processing station 40 is disposed adjacent to the tank 12.

The second post-processing station 42, as shown in FIGS. 1 and 2, is a post-curing station configured to further cure the printed object 20 externally of the tank 12. Post-curing facilitates the polymerization process to ensure the resin of the printed object 20 is fully cured. The second post-processing station 42 is disposed adjacent to the tank 12. The printed object 20 is preferably brought to the second post-processing station 42 after the first post-processing station 40.

The control arm 14 moves the first printing tool 32A to the mounting rack 34 of the tool station 30 after printing the printed object to return the first printing tool 32A to the mounting rack 34, as shown in FIG. 4. The tool adapter 26 releases the first printing tool 32A. The control arm 14 then picks up the second printing tool 30B with the tool adapter 26 to print another object.

The mounting rack 34 of the tool station 30 includes a mounting member 46 configured to mount the mounting rack 34 to a support 48, as shown in FIGS. 1-4. The mounting member 46 includes a plurality of elongated openings 46A configured to adjust a position of the mounting rack 34 on the support 48 of the tool station 30. The support 48 is mounted on the platform 50 of the tool station 30.

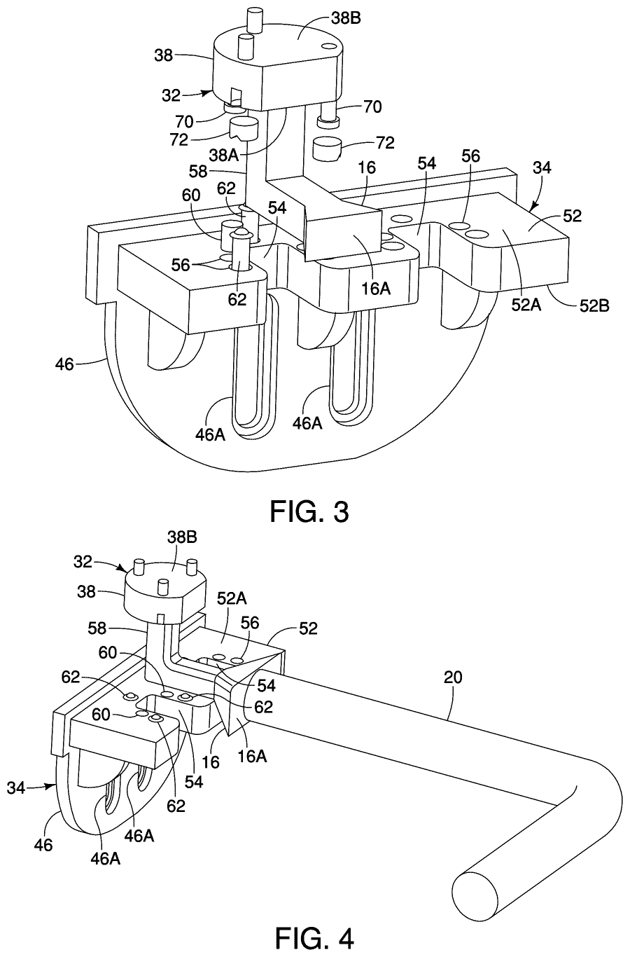

The mounting rack 34 of the tool station 30 includes a support member 52, as shown in FIGS. 3 and 4. The support member 52 includes an upper surface 52A and a lower surface 52B. The upper surface 52A and the lower surface 52B are substantially planar.

A plurality of recesses 54 are disposed in the support member 52, as shown in FIGS. 1-6. Each of the plurality of recesses 54 is configured to receive one of the plurality of printing tools 32. Each recess 54 of the plurality of recesses 54 is similarly configured. The recess 54 extends from the upper surface 52A to the lower surface 52B of the support member 52 such that a connecting arm 58 of the printing tool 32 passes therethrough when received by the recess 54. The recess includes a first side wall 54A and a second side wall 54B. The second side wall 54B is preferably substantially parallel to the first side wall 54A. A rear wall 54C connects rear ends of the first and second side walls 54A and 54B. The first side wall 54A, the second side wall 54B and the rear wall 54C define the recess 54 in the support member 52. The recesses 54 extend from a front surface, or front edge, 52C of the support member 52 toward the mounting member 46. In other words, each of the plurality of recesses 54 extends inwardly from a same edge of the support member 52.

A plurality of first openings 56 are disposed in the support member 52 and surround each of the plurality of recesses 54, as shown in FIG. 6. Five first openings 56 are shown surrounding each of the plurality of recesses 54, although any suitable number of first openings 56 can surround each recess 54. Each first opening 56 extends downwardly from the upper surface 52A of the support member 52 toward the lower surface 54B. Preferably, the first openings 56 do not extend completely through the support member 52 from the upper surface 52A to the lower surface 52B.

At least one magnet 60 is disposed in one of the first openings 56, as shown in FIGS. 3-6. At least one spring ball plunger 62 is disposed in another one of the first openings 56. Two magnets 60 and three spring ball plungers 62 are disposed in the five first openings 56, although any suitable combination of magnets 60 and spring ball plungers 62 can be used. Each magnet 60 is disposed between a pair of adjacent spring ball plungers 62.

A first magnet 60 of the two magnets is disposed on a first side S1 of the recess 54, and a second magnet 60 is disposed on a second side S2 of the recess 54. The first side S1 is on an opposite side of a longitudinal axis A of the recess 54 from the second side S2, as shown in FIG. 6.

Each magnet 60 is preferably similarly configured. Each magnet 60 is a permanent magnet. Alternatively, each magnet 60 can be an electromagnet. A strength of a magnetic field generated by the electromagnet can be controlled. The strength of the magnetic field can be adjusted based on a weight of the printing tool 32 received by one of the recesses 54. When a printing tool 32 is received by one of the recesses 54 prior to having an object printed thereon, the electromagnet can be controlled to generate a magnetic field having a first strength. When the printing tool 32 is received by one of the recesses 54 after having an object 20 printed thereon, the electromagnet can be controlled to generate a magnetic field having a second strength to more securely retain the heavier printing tool on the support member 52 of the tool station 30. The magnet 60 is received in the first opening 56 in any suitable manner, such as, but not limited to, by a threaded connection, with an adhesive, or by a press fit. The position of the threaded permanent magnet is adjustable relative to the upper surface 52A of the support member 52 to control a strength of the magnetic force between the magnets 60 and 70 when the printing tool 32 is received by the mounting rack 34.

A first spring ball plunger 62 of the three spring ball plungers is disposed on the first side S1 of the recess 54, as shown in FIG. 6. A second spring ball plunger 62 of the three spring ball plungers is disposed on the second side of the recess 54. A third spring ball plunger 62 of the three spring ball plungers is disposed on the longitudinal axis A of the recess 54. The magnets 60 and the spring ball plungers 62 are preferably symmetrically disposed relative to the longitudinal axis A.

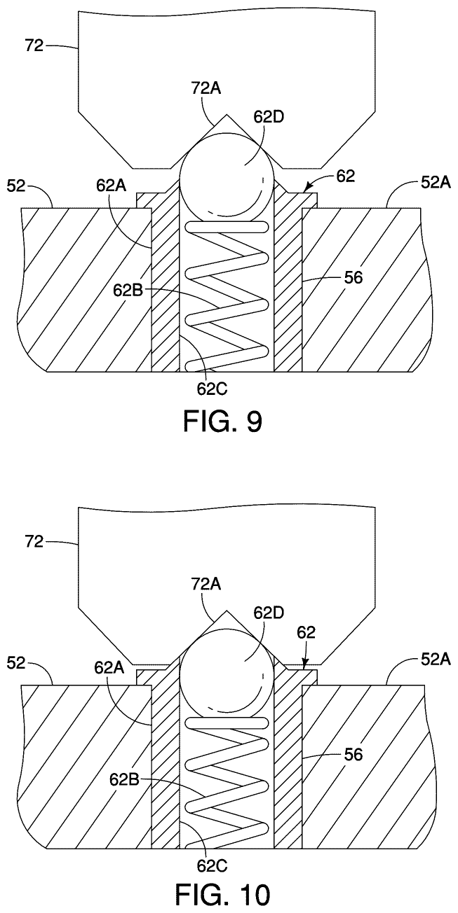

Each of the spring ball plungers 62 is preferably similarly configured. As shown in FIGS. 9 and 10, the spring ball plunger 62 includes a body 62A disposed in the first opening 56. The body 62A is secured in the first opening 56 in any suitable manner, such as, but not limited to, by a threaded connection, with an adhesive, or by a press fit. The body 62A is a substantially tubular member. A biasing member 62B, is received in a passage 62C formed in the body 62A. An end of the biasing member 62B receives a ball member 62D. The biasing member 62B biases the ball member 62D to a first position, as shown in FIG. 9. The biasing member 62B is configured to be compressed within the body 62A when an object contacts and applies a downward force to the ball member 62D, as shown in FIG. 10. A first end of the biasing member 62B is fixed to the body 62A, such that the second end of the biasing member 62B receiving the ball member 62D can move downwardly in the passage 62C when the object engages the ball member 62D.

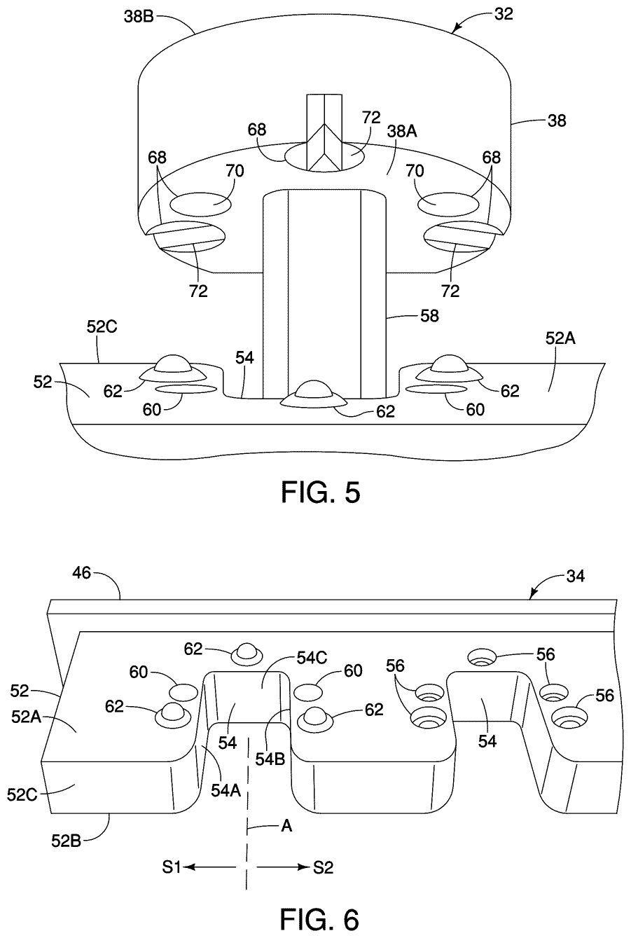

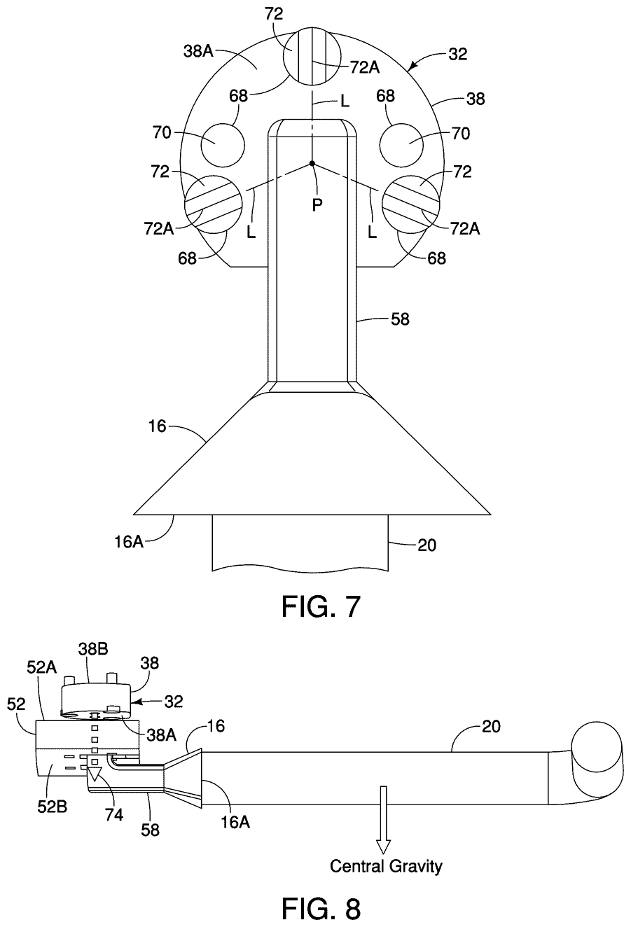

The connecting member 38 of the printing tool 32 includes a receiving surface 38A having a plurality of second openings 68 disposed therein, as shown in FIGS. 5 and 7. The receiving surface 38A is preferably a substantially planar surface. The plurality of second openings 68 are disposed in the receiving surface 38A of the connecting member 38 and are configured to align with the plurality of first openings 56 in the support member 52 of the tool station 30. The number of second openings 68 is preferably equal to the number of first openings 56. In other words, the number of the plurality of second openings 68 in the printing tool 32 is the same as a number of the plurality of first openings 56 surrounding each of the recesses 54. Five second openings 68 are shown in the receiving surface 38A of the connecting member 38 of the printing tool 32, although the connecting member 38 can have any suitable number of second openings 56. Each second opening 68 extends upwardly from the receiving surface 38A of the connecting member 38 toward the connecting, or upper, surface 38B. The connecting surface 38B of the connecting member 38 is configured to engage the tool adapter 26 of the control arm 14. Preferably, the second openings 68 do not extend completely through the connecting member 38 from the receiving surface 38A to the connecting surface 38B.

At least one magnet 70 is disposed in one of the second openings 68, as shown in FIGS. 5 and 7. At least one receiving member 72 is disposed in another one of the second openings 68. Two magnets 70 and three receiving members 72 are disposed in the five second openings 68, although any suitable combination of magnets 70 and receiving members 72 can be used. Each magnet 70 is disposed between a pair of adjacent receiving members 72.

Each magnet 70 of the printing tool 32 is preferably similarly configured. Each magnet 70 is preferably a permanent magnet. The magnet 70 is received in the second opening 68 in any suitable manner, such as, but not limited to, by a threaded connection, with an adhesive, or by a press fit. Preferably, the magnet 70 is threadedly engaged with the second openings 68 to a adjust a position of an upper, or exposed, surface of the magnet 70 relative to the receiving surface 38A of the receiving member 38 to control the strength of the magnetic field generated by the magnet 70.

Each receiving member 72 is preferably substantially disc-shaped, as shown in FIG. 3. An exposed surface of each receiving member has a V-shaped groove 72A disposed therein, as shown in FIGS. 5 and 7. A virtual line L along each of the V-shaped grooves intersect in a point P on the receiving surface 38A of the connecting member 38 of the printing tool 32, as shown in FIG. 7. The aligned V-shaped grooves 72A provide restraint in six degrees of freedom. A longitudinal axis through the point P does not pass through the print surface 16A. The magnets 70 and the receiving members 72 are preferably symmetrically disposed relative to a longitudinal access through the connecting member 38 corresponding to the longitudinal axis A when the printing tool 16 is received by the mounting rack 34. The receiving member 72 is not limited to a substantially disc-shaped member having a V-shaped groove, and can be any suitable member that provides two points of contact with the ball member 62D of the spring ball plunger 62, such as a pair of spaced apart cylinders, such as dowel pins. The spaces between the pair of cylinders are oriented such that a virtual line therethrough intersects in a point on the receiving surface 38A of the connecting member 38.

The V-shaped grooves 72A of the receiving members 72 are configured to engage the corresponding ball member 62D of the spring ball plunger 62, as shown in FIGS. 1, 9 and 10, when the printing tool 32 is received by one of the plurality of recesses 54 of the tool station 30. The magnets 60 of the mounting rack 34 of the tool station 30 attract the corresponding magnets 70 of the connecting member 38 of the printing tool 32 to securely retain the printing tool 32 to the tool station 30. The receiving members 72 of the connecting member 38 of the printing tool 32 engage the corresponding spring ball plungers 62 of the mounting rack 34 of the tool station 30. As shown in FIGS. 8 and 10, a force 74 is exerted on the connecting member 38 when connecting to or disconnecting from the tool adapter 26 of the control arm 14. The downward force 74 is absorbed by compression of the biasing member 62B of the spring ball plunger 62, which acts as a shock absorber, as shown in FIG. 10. The biasing member 62B then returns to a position shown in FIGS. 8 and 9 to maintain the positional accuracy of the printing tool 32 on the mounting rack 34 of the tool station 30. Each V-shaped groove 72A in the receiving member 72 receives one of the ball members 62D of the spring ball plungers 62 to form a kinematic coupling therebetween. The kinematic coupling facilitates maintaining positional accuracy of the printing tools 32 to allow the printing tools to be easily picked up by the control arm 14. The kinematic coupling, in addition to the magnets 60 and 70, further secures the printing tool 32 to the mounting rack 34 of the tool station 30 against gravity, ambient vibrations, and other forces imparted to the tool station. The eccentric arrangement of the printing tool 32 when the printed object 20 is connected thereto in which the center of gravity is spaced from the mounting rack 34, as shown in FIG. 8, is accommodated by the kinematic coupling and the magnets 60 and 70 to maintain the positional accuracy of the printing tool 32 on the tool station 30. The kinematic coupling and the magnets 60 and 70 maintain the receiving surface 38A of the connecting member 38 substantially parallel to the upper surface 52A of the support member 52 of the mounting rack 34, thereby maintaining the stability and positional accuracy of the printing tool 32 when received by the tool station 30.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the mounting rack and tool for a three-dimensional printing system. Accordingly, these terms, as utilized to describe the present invention should be interpreted relative to a three-dimensional printing system including the mounting rack and tool.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A three-dimensional printing system comprising:
a printing tool including a rigid base on which an object is configured to be printed;
a control arm removably connected to the rigid base and configured to move the rigid base; and
a mounting rack configured to store a plurality of printing tools, the mounting rack including
a support member;
a plurality of recesses disposed in the support member, each of the plurality of recesses being configured to receive one of the plurality of printing tools;
a plurality of first openings disposed in the support member and surrounding each of the plurality of recesses;
a magnet disposed in one of the plurality of first openings; and
a spring ball plunger disposed in another one of the plurality of first openings.

2. The three-dimensional printing system according to claim 1, wherein
each of the plurality of recesses extends inwardly from a same edge of the support member.

3. The three-dimensional printing system according to claim 1, wherein
five first openings surround each of the plurality of recesses.

4. The three-dimensional printing system according to claim 3, wherein
two magnets and three spring ball plungers are disposed in the five first openings.

5. The three-dimensional printing system according to claim 4, wherein
a first magnet of the two magnets is disposed on a first side of the recess, and a second magnet of the two magnets is disposed on a second side of the recess, the first side being on an opposite side of a longitudinal axis of the recess from the second side.

6. The three-dimensional printing system according to claim 5, wherein
a first spring ball plunger of the three spring ball plungers is disposed on the first side of the recess, and a second spring ball plunger of the three spring ball plungers is disposed on the second side of the recess.

7. The three-dimensional printing system according to claim 6, wherein
a third spring ball plunger is disposed on the longitudinal axis of the recess.

8. The three-dimensional printing system according to claim 1, wherein
the magnet is a permanent magnet.

9. The three-dimensional printing system according to claim 1, wherein
the magnet is an electromagnet.

10. The three-dimensional printing system according to claim 9, wherein
a strength of the magnet is adjusted based on a weight of the printing tool received by one of the recesses.

11. The three-dimensional printing system according to claim 1, wherein
the printing tool includes a receiving surface having a plurality of second openings therein,
a magnet is disposed in one of the plurality of second openings; and
a receiving member is disposed in another one of the plurality of second openings.

12. The three-dimensional printing system according to claim 11, wherein
a number of the plurality of second openings in the printing tool is the same as a number of the plurality of first openings surrounding each of the recesses.

13. The three-dimensional printing system according to claim 11, wherein
the receiving surface of the printing tool has five second openings.

14. The three-dimensional printing system according to claim 13, wherein
two magnets and three receiving members are disposed in the five second openings.

15. The three-dimensional printing system according to claim 11, wherein
the magnet is a permanent magnet.

16. The three-dimensional printing system according to claim 14, wherein
the receiving member includes a V-shaped groove.

17. The three-dimensional printing system according to claim 11, wherein
the receiving member is configured to engage the spring ball plunger when the printing tool is received by one of the plurality of recesses of the mounting rack.

18. The three-dimensional printing system according to claim 14, wherein
each of the three receiving members includes a V-shaped groove, virtual lines through each of the V-shaped grooves intersecting in a point on the receiving surface of the printing tool.

19. The three-dimensional printing system according to claim 1, wherein
the magnet is threadedly engaged with one of the first openings to adjust a position of an upper surface of the magnet relative to the planar surface.

20. A robot-assisted system comprising:
a tool;
a control arm removably connected to the tool and configured to move the tool; and
a mounting rack configured to store a plurality of tools, the mounting rack including
a support member;
a plurality of recesses disposed in the support member, each of the plurality of recesses being configured to receive one of the plurality of tools;
a plurality of first openings disposed in the support member and surrounding each of the plurality of recesses;
a magnet disposed in one of the plurality of first openings; and
a spring ball plunger disposed in another one of the plurality of first openings.
